(19) United States
(12) Patent Application Publication
(10) Pub. No.: US 2025/0074105 A1
(43) Pub. Date: Mar. 6, 2025

(54) METHOD FOR ENHANCING AN IMAGE AND ENHANCED PRINTED IMAGE WITH THREE-DIMENSIONAL FEATURES

(71) Applicant: Artobotics, LLC, Santa Monica, CA (US)

(72) Inventors: Hank B. Ridless, Santa Monica, CA (US); Pindar Van Arman, Fort Worth, TX (US)

(73) Assignee: Artobotics, LLC, Santa Monica, CA (US)

(21) Appl. No.: 18/241,981

(22) Filed: Sep. 4, 2023

(51) Int. Cl. B44F 11/02; B29C 51/10; G06T 11/00; G06T 11/60

(52) U.S. Cl. CPC B44F 11/02; B29C 51/10; G06T 11/001; G06T 11/60; B29L 2031/722

(57) ABSTRACT

A method for enhancing an image. A sheet having an image formed thereon, and a digital file of the image, are provided. Three-dimensional artistic embellishments having features are applied to an area of the image on the sheet. The image in the digital file is modified in the area to resemble at least some of the features of the artistic embellishments applied to the image on the sheet. The modifications may be the addition of color to the area. A print of the modified image with three-dimensional artistic embellishments is provided.

### CROSS REFERENCE TO RELATED APPLICATION

This application claims priority International Application No. PCT/US2022/019039 filed Mar. 4, 2022, which claims priority to U.S. provisional patent application Ser. No. 63/157,584 filed Mar. 5, 2021, the entire content of each of which is incorporated herein by this reference.

### SCOPE OF THE INVENTION

The present invention relates to printed images, and more particularly to printed image images having three-dimensional artistic embellishments.

### BACKGROUND

Embellished artwork can refer to printed graphic images onto which three dimensional artistic embellishments are then added to the surface. Most commonly, embellished artwork refers to printed copies of original artworks onto the surface of which paint or other elements are applied.

There is a need for a new method for providing printed images with three-dimensional artistic embellishments that involves less labor and is less expensive.

### BRIEF DESCRIPTION OF FIGURES

The figures herein are all schematic and not drawn to scale. The drawings are for illustration purposes only and are not intended to limit the scope of the present disclosure.

FIG. 1 is a plan view of a digital image.

FIG. 2 is a plan view of a mold with a plurality of three-dimensional features on a surface of the mold.

FIG. 3 is a plan view a the digital image of FIG. 1 modified to include a plurality of areas of color.

FIG. 4 is a plan view of a substrate with the modified image of FIG. 3 printed thereon.

FIG. 5 is an isometric view of a suitable vacuuming forming assembly for use in the methods of the invention.

FIG. 6 is an isometric view of the mold of FIG. 2 disposed on the vacuum surface of the assembly of FIG. 5.

FIG. 7 is an isometric view of the substrate with printed modified image of FIG. 4 overlying the mold disposed on the vacuum forming assembly as shown in FIG. 6.

FIG. 8 illustrates the step of applying heat to the substrate with printed modified image overlying the mold disposed on the vacuum forming assembly as shown in FIG. 7.

FIG. 9 illustrates the step of providing vacuum to the vacuum forming assembly of FIG. 5 to press the substrate with printed modified image of FIG. 4 on to the mold of FIG. 2 disposed on the vacuum surface of the vacuum forming assembly.

FIG. 10 illustrates the substrate with printed modified image of FIG. 4 having three-dimensional features formed therein.

FIG. 11 is an isometric view of the substrate with printed modified image having three-dimensional features formed therein of FIG. 10 removed from the vacuum forming assembly.

FIG. 12 a plan view of the substrate with printed modified image having three-dimensional features formed therein of FIG. 11.

### DETAILED DESCRIPTION OF THE INVENTION

The methods of the invention relate to enhancing an image, by for example modifying a digital copy of the image. The image can be of anything, for example of a photograph, a painting, an artistic creation or any combination of the foregoing. The digital image, or the digital file of the image, can be modified, wholly or at least in certain areas, to include at least some of the attributes of artistic features or embellishments that may be present in a print of the image. Such attributes can also be referred to as aspects or elements of the artistic features or embellishments. The modifications can serve to highlight or enhance the attributes, the artistic features or embellishments or both. The modifications to the digital image or file can be made by a processor, computer or computing device. The modifications to the digital image can optionally be made in the area or region of the digital image where the artistic embellishments may be present in the print of the image, for example the print of the modified image. For example, a print of the image may include three-dimensional artistic embellishments, and the modifications to the digital image can include some or certain attributes of such embellishments. The modifications to the digital image can optionally made to additionally indicate where artistic embellishments are to be added to the print of the modified image. For example, the modified image can be projected onto a surface on to which the artistic features or embellishments are created as part of a mold-making process to create a print of the modified image with three-dimensional artistic features or embellishments.

The three-dimensional artistic embellishments can be of any suitable type, and can optionally include artistic embellishments that are or resemble three-dimensional embellishments created by an art tool, a brush, a pallet knife, a squeeze bottle, a painting tool, any tool that can apply paint, any tool that can apply a chemical or any combination of the foregoing. The three-dimensional artistic embellishments can optionally be or resemble brushstrokes, for example brushstrokes of a painting. The three-dimensional artistic embellishments herein can optionally be referred to as three-dimensional embellishments or three-dimensional features.

The attributes of the features or embellishments can be of any suitable type, and can optionally include, for example, physical attributes, topographic attributes, elevational attributes, lines, three-dimensional lines, shapes, three-dimensional shapes, surfaces, three-dimensional surfaces, color or any combination of the foregoing. Any color added in the modification of the digital image can optionally include additional color, including for example any color not present in the area or region being modified before such modification.

The methods of the invention can optionally include printing the modified image on a substrate and forming the three dimensional artistic embellishments, or features, in the substrate. The substrate can be of any suitable type, and forming the three-dimensional or embellishments, or features, in the substrate can be in any suitable manner. The substrate can optionally include any material or sheet onto which an image may be digitally printed. The substrate can optionally include any suitable flexible material or sheet, bendable material or sheet, formable material or sheet or any combination of the foregoing. The substrate can optionally include a thermoformable or thermoplastic substrate or sheet. The three-dimensional embellishments, or features, can optionally be vacuum formed into any suitable thermoformable or thermoplastic substrate or sheet.

The invention can include a modified print of an original image. A substrate or sheet, which can optionally be referred to as a substrate sheet, can be provided and the modified image, for example of the type disclose above or herein, can be printed on the sheet. The substrate or sheet can optionally include any of the substrates or sheets disclosed above or herein. Three-dimensional embellishments, or features, can optionally be formed in the substrate or sheet, for example in a plurality of areas or regions of the image. The printed image, and the digital file used to create the printed image, can include modifications from the original image, that is be modified from the original image, in at least some of the plurality of areas or regions with respect to the three-dimensional embellishments, or features. Such modifications can be of any type, and include for example, physical attributes, lines, three-dimensional lines, shapes, three-dimensional shapes, surfaces, three-dimensional surfaces, color or any combination of the foregoing. Any color added in the modification of the digital image can optionally include additional color or any color not present in the area or region being modified before such modification.

A modified printed image of the invention can be mounted on any suitable support structure of an image display. The image display can optionally have the appearance of an image substrate mounted on a wooden stretcher bar frame. The support structure can optionally have a size and shape resembling a wooden stretcher bar frame. The support structure can optionally be a wooden stretcher bar frame. The support structure can be formed from any suitable material, including paper, cardboard, paperboard, corrugated board, fiberboard, wood, metal, plastic, foam or any combination of the foregoing. The support structure can be a unitary structure, for example made from a single piece or block of material, or formed from a plurality of parts. The support structure can optionally be any of the types disclosed in U.S. Pat. No. 8,959,812, the entire content of which is incorporated herein by this reference. The support structure can optionally be any of the types disclosed in International Application No. PCT/US21/43803, the entire content of which is incorporated herein by this reference.

The printed substrate can extend over at least the front of the support structure, and optionally over any peripheral portions of the support structure. The printed substrate can optionally extend to the back of the support structure, and be secured to the support structure by any suitable means such as an adhesive.

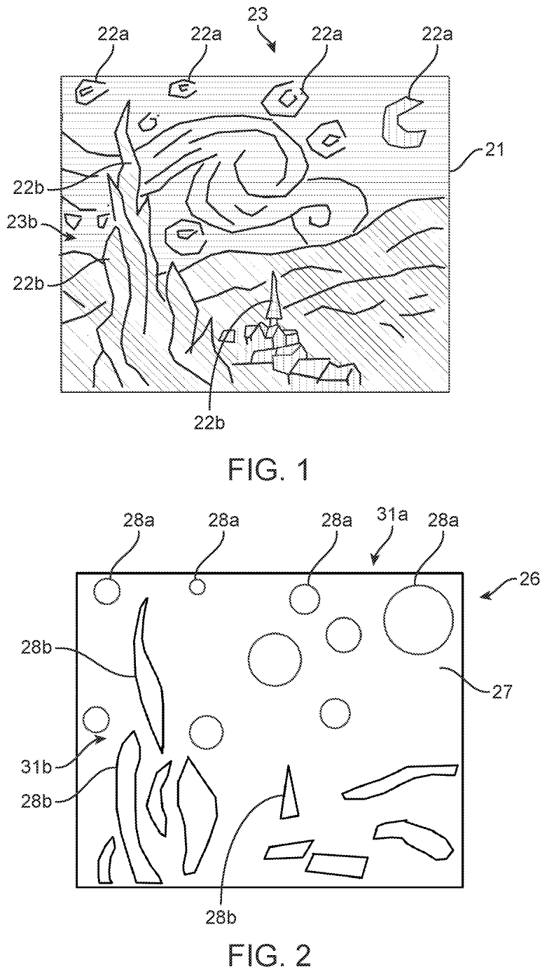

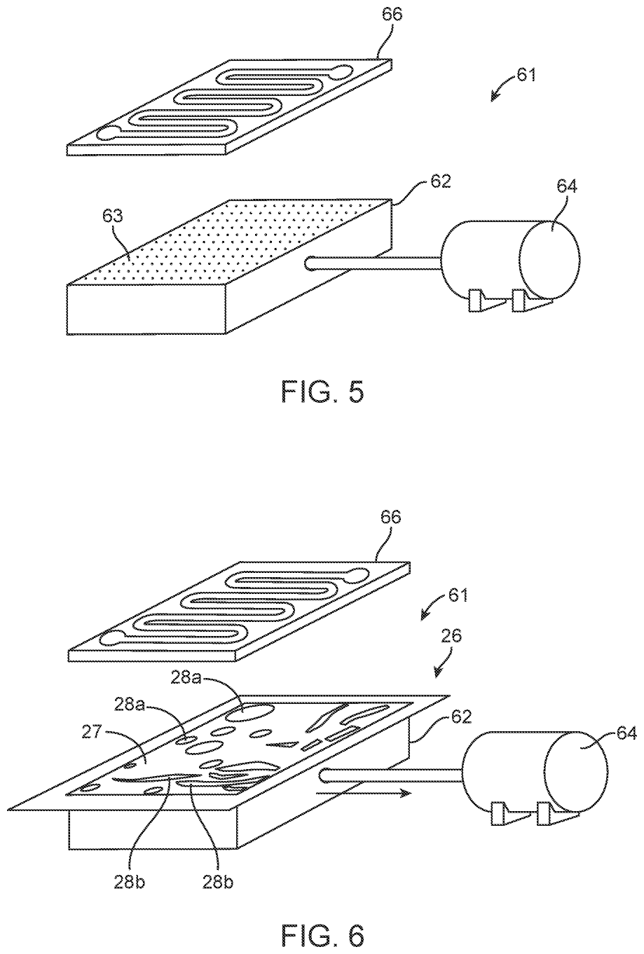

An optional method of the invention for enhancing an image is as follows, and shown for example in FIGS. 1-12. An original image 21 is provided (see FIG. 1). The original image can be in the form of a digital file, and referred to as an original digital image 21. The original image 21 can be of anything, for example of a photograph, a painting, an artistic creation or any combination of the foregoing. The original image can have a plurality areas or regions 22, for example areas forming part of the artistic expression of the image. The areas 22 can optionally be arranged in a plurality of patterns 23, for example a first pattern 23a of first areas 22a and a second pattern 23b of second areas 22b.

A mold 26 can optionally be provided (see FIG. 2). The mold 26 can optionally be a positive mold or a negative mold. The mold 26 can be formed in any suitable manner, for example in any of the manners or methods disclosed in International Application No. PCT/US22/15377, the entire content of which is incorporated herein by this reference. The mold can have a surface 27 with a plurality of features 28, for example three-dimensional features, provided or formed on the surface 27. The features 28 can optionally be referred to as artistic embellishments or three-dimensional artistic embellishments. The features 28 can include a first plurality of features 28a and a second plurality of features 28b. The plurality of features 28 can be arranged in patterns 31, for example the plurality of first features 28a in a first pattern 31a and the plurality of second features 28b in a second pattern 31b. The three-dimensional features or embellishments 28 can be or resemble three-dimensional embellishments created by an art tool of any suitable type, for example a brush, a pallet knife, a squeeze bottle, a painting tool, any tool that can apply paint, any tool that can apply a chemical or any combination of the foregoing. The three-dimensional features or embellishments 28 can optionally be or resemble brushstrokes, for example brushstrokes of a painting. The three-dimensional features or embellishments 28 can optionally have attributes or aspects of any suitable type, for example physical attributes, topographic attributes, elevational attributes, lines, three-dimensional lines, shapes, three-dimensional shapes, surfaces, three-dimensional surfaces, color and any combination of the foregoing. The color can optionally be additional color. For purposes herein, additional color means color that was not previously present in the location to which added. The attributes can optionally be referred to as aspects, elements or features of the artistic embellishments.

The mold 26 can optionally pertain to the original image 21. In this regard, the mold 26 can optionally have a size and shape that can correspond to a size and shape of the original image 21. The three-dimensional features or embellishments 28 can optionally be located on the mold surface 27 so as to correspond to some or all of the areas 22 of the original image 21. For example, the first plurality of features or embellishments 28a can optionally be located on the mold surface 27 so as to correspond to the first areas 22a of the original image 21 and the second plurality of features or embellishments 28b can be located on the mold surface 27 so as to correspond to the second areas 22b of the original image 21. The first pattern 31a of first features 28a can optionally correspond to or be the same as the first pattern 23a of first areas 22a of the original image 21 and the second pattern 31b of second features 28b can optionally correspond to or be the same as the second pattern 23b of second areas 22b of the original image 21. Each three-dimensional features or embellishment 28 on the surface 27 of the mold can optionally have a two-dimensional shape that is the same, approximately the same or resembles as the two-dimensional shape of the respective area 22 of the original image 21.

The mold 26 can optionally pertain to a copy, print or version of the original image 21 on which the three-dimensional artistic features or embellishments 28 are provided. The mold 26 can optionally be formed from, or with the use of, a print, or other tangible formation, of the original image 21 on to which the three-dimensional features or embellishments 28 have been formed. The mold can optionally be formed from, or with the use of, a sheet on to which the three-dimensional features or embellishments 28 have been formed in areas that correlate to the areas 22 of the original print.

In an optional method step, the digital file of the original image 21 can be modified in at least some of the areas 22, for example as a function of the artistic feature or embellishment 28 on the mold surface 27 corresponding to such area 22. The modifications to the digital image or file can be made by a processor, computer or computing device. The digital file of the original image 21 can optionally modified in at least some of the areas 22 to resemble, reflect, enhance, emphasize or highlight at least some attribute of the artistic feature or embellishment 28 on the mold surface 27 corresponding to such area. For example, additional color can optionally be added to an area 22 of the digital file. For example, the digital file of the original image can optionally be modified to add a line, object, texture, color or any combination of the foregoing to such area to resemble, reflect, enhance, emphasize or highlight at least some attribute of the artistic feature or embellishment 28 corresponding to such area. The digital file of the original image 21 can optionally be modified in the first areas 22a in one manner with respect to the plurality of first features or embellishments 28 and in the second areas 22b in another manner with respect to the plurality of second features or embellishments 28. The modifications to the digital image can optionally resemble, reflect, enhance, emphasize or highlight at least some of the attributes of the artistic features or embellishments 28 formed on a print of the original image 21, for example from which the mold 26 was formed or utilized in the formation of the mold 26. For example, additional color can optionally be added to an area 22 of the digital file. The color may be the same as or correspond to the color in which the feature or embellishment 28, or an attribute thereof, was formed on a copy, print or version of the original image 21.

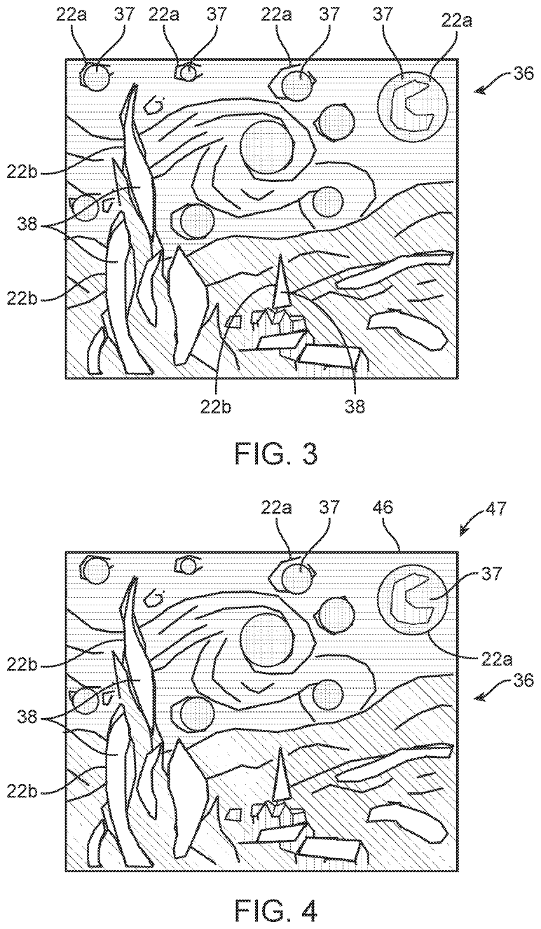

The optional step of modifying the digital file or the original image 21, which can be referred to as the digital image, provides a modified digital image or modified image 36 (see FIG. 3). The modified image 36 can optionally include a plurality of areas of additional color, including for example a plurality of areas of a first additional color and a plurality of areas of a second additional color that is the same as or different from the first additional color. An optional modified image 36 includes the digital image with a first color 37, for example a first additional color, added to each first area 22a of the image and a second color 38, for example a second additional color, added to each second area 22b of the image. Each area of additional color in the modified image can optionally have a two-dimensional shape that is the same, approximately the same or resembles as the two-dimensional shape of the respective feature or embellishment 28 of the mold or respective attribute of such feature or embellishment 28. The modifications to the original image in an area 22 corresponding to an artistic feature or embellishment can optionally include creating a plurality of defined regions or subareas in the area 22 and defining a different color for each of such defined regions or subareas. Each region or subarea can be of any shape and size, and together can form any desired object or geometric shape. For example, one region or subarea can define a line, strip or surface. The added, or selected color of each region or subarea can be easily changed in the digital file to create different versions of the modified image 36, for example different color schemes in an area 22 of the modified image 36. The modified image 36 in FIG. 3 illustrates certain principles of the invention described herein, but is not intended to limit the scope of the invention with respect to such principles.

In an optional step, the modifications to the digital original image 21 can be made before the creation of mold 26 and the modified image 36 used to indicate where artistic features or embellishments 28 are to be added to the print of the modified image 36. For example, the modified image 36 can be projected onto a surface on to which the artistic features or embellishments are created as part of the process for creating mold 26. For example, the features or embellishments 28 can be added within the confines of the modified areas of image 36. For example, original image 21 can be digitally modified to add locations of color, for example first color 37, second color 38 or both. Such two-dimensional color included in the modified image 36 can be used to identify where corresponding artistic features or embellishment 28 are to be added to the print of the modified image 36, to mold 26 or both. For example, features or embellishments 28 can be added to image 21 within the confines of the areas of added color.

In an optional step, a substrate 46 of any suitable type is provided. The substrate 46 can optionally be referred to as a thermoformable substrate or a thermoplastic substrate, for example for use with mold 26. The substrate can optionally be made from polyester, polypropylene (PP), polystyrene, polyvinyl chloride (PVC), a rigid PVC or any suitable thermoformable or thermoplastic material. Substrate 46 can optionally be made from any thermoformable or thermoplastic material that can be printed with conventional printing methods. Optional printing methods include digital printing, digital inkjet printing, offset printing and flexographic printing. The material of substrate 46 is optionally suitable for use in a vacuum forming process. Substrate 46 can be of any suitable size, shape and thickness. For example, the substrate can optionally have a size and shape at least as large as original image 21. Substrate 46 can optionally be a sufficiently thin film or layer such that, after any thermoforming process with mold 26, the features or embellishments on surface 26 of the mold 26 will be clearly detailed on the surface of the substrate 46. The substrate can optionally have any thickness suitable for thermoforming, for example a thickness of 0.003 inch or a thickness ranging from 0.002 to 0.020 inch.

In an optional step, a modified digital image 36 is formed on the substrate 46 in any suitable manner to form a printed substrate 47 having modified image 36 printed thereon (see FIG. 4). The modified image 36 can be provided on at least the central portion of the substrate 46, for example on the outer surface of the substrate. The image can optionally, additionally be provided on one or more of the peripheral portions of the substrate 46. The modified image 36 can optionally be printed on substrate 46 in any suitable manner, for example any conventional printing method, to form a printed image 36 on the substrate 46. Optional printing methods include digital printing, digital inkjet printing, offset printing and flexographic printing. Printed modified image 36 on the printed substrate 47 can, for example, include modifications in at least some of areas 22 to resemble, reflect or highlight at least some attribute of the artistic feature or embellishment 28 on the mold surface 27 corresponding to such area. In the sample illustration of FIG. 4, printed substrate 47 includes a first color 37 in each first area 22a of the modified image 36 and second color 38 in each second area 22b example a second additional color, added to each second area 22b of the modified image 36. First pattern 23a of first areas 22a of the modified image 36 is optionally the same a first pattern 31a of first artistic features or embellishments 28a on mold surface 27 and second pattern 23b of second areas 22b of the modified image 36 is optionally the same a second pattern 31b of second artistic features or embellishments 28b on the mold surface 27.

In an optional step, a vacuum system 61 can be provided (see FIGS. 6-10). The vacuum system can optionally be a conventional vacuum system. The vacuum system 61 can optionally include a vacuum table 62, having a vacuum surface 63, coupled to a pneumatic pump 64 of any suitable type for providing negative pressure or vacuum to surface 63.

In an optional step, a heater or heating element 66 can be provided (see FIGS. 6-10). The heater 66 can be of any suitable type, for example any conventional heater or heater suitable for use with a vacuum table 62.

In an optional step, mold 26 is positioned on vacuum table 62, optionally overlying vacuum surface 63 of the vacuum table to that suction or negative pressure from the vacuum table can draw air through the mold 26 (see FIG. 6). Surface 27 of the mold 26 is disposed upwardly or facing away from the vacuum table 62. Any suitable porous member or other porous support (not shown) can optionally be disposed between the mold 26 and surface 63 of the vacuum table 62 for providing support to the mold 26 during the optional vacuum-forming step and the optional thermoforming step of the method.

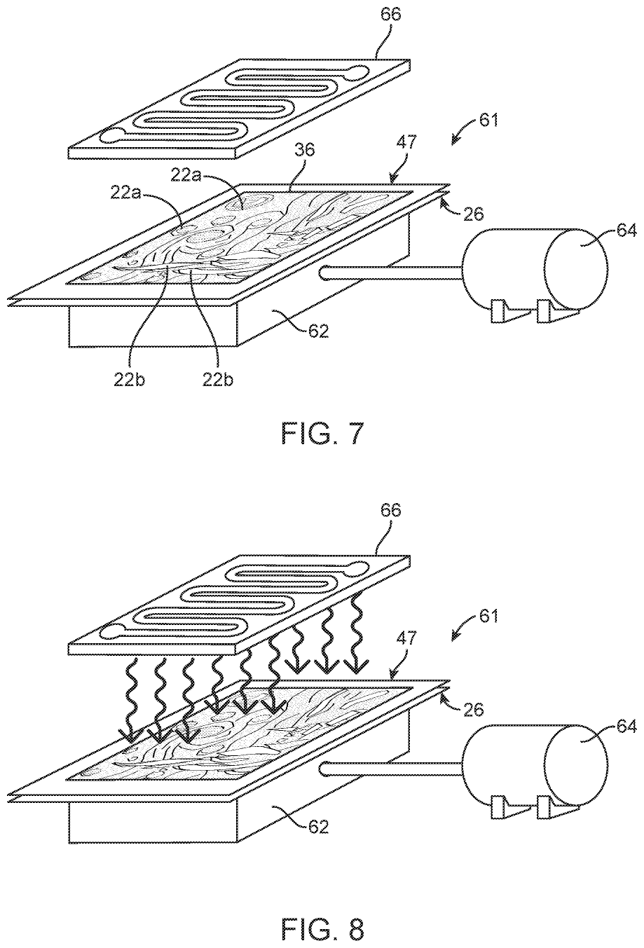

In an optional step, printed substrate 47 is positioned over mold 26 (see FIG. 7). The printed substrate 47 is optionally aligned with the mold 26, the vacuum surface 63 or both so that the first areas 22a and second areas 22b, and corresponding first pattern 23a and second pattern 23b, of the modified image 36 on the printed substrate 47 are desirably or properly aligned or registered with the respective first features 28a and second features 28b, and corresponding first pattern 31 and second pattern 31, on the mold surface 27. For example, the plurality of modifications to the original image 21 can be registered for aligned with the respective attributes of the features or embellishments 28 corresponding to such modifications. For example, the plurality of added colors to the modified image 36 can be aligned or registered with respective attributes of the features or embellishments 28 corresponding to such added colors. The printed substrate 47 can optionally be placed directly on the mold 26. The printed substrate 47 can optionally be positioned close to but above the mold 26. Relatively small height differentials between peaks and troughs of the artistic features or embellishments 28 of the mold 26 can facilitate the printed substrate 47 being placed directly on or close to the mold 26. Modified image 36 provided on the printed substrate 47, and the surface of the substrate 46 on which the image 36 is formed, can optionally face away from the mold 26 and vacuum surface 63 of the vacuum table, as shown in FIG. 7. For example, the mold 26 can serve as a positive mold. It is appreciated that modified image 36 provided on the printed substrate 47, and the surface of the substrate 46 on which the image 36 is formed, can optionally face vacuum surface 63 of the vacuum table (not shown). For example, the mold 26 can be configured to serve as a negative mold.

In an optional step, the perimeter of the printed substrate 47 can be clamped to the vacuum system 61 (not shown), for example to the vacuum table 62, so that the printed substrate is held in place, for example relative to the mold 26, the vacuum table 62 or both. Such clamping can facilitate proper alignment or registration of the areas 22 of the modified image 356 with the respective three-dimensional features or artistic embellishments 28 on the mold 26 throughout the vacuum forming process. The printed substrate 47 can optionally not be clamped to the vacuum system 61, for example when the shrinking, movement or both of the printed substrate 47 results in an acceptable finished product.

In an optional step, the printed substrate 47 is heated, for example to a desired temperature, to permit deformation of the substrate 47, for example in a thermoforming step (see FIG. 8). The printed substrate can be heated in any suitable manner, for example by a suitable heater appropriately positioned relative to the printed substrate 47. Heater 66, overlying the printed substrate 47 and the mold 26, can optionally be used to provide heat to the printed substrate.

In an optional step, sufficient vacuum or negative pressure is provided to vacuum table 62, for example from pump 64, to press or draw printed substrate 47 on to mold 26 to cause the features or artistic embellishments 28 on the mold to deform the printed substrate, for example in a thermoforming process or step (see FIG. 9). The deformation of the printed substrate 47 by the mold 26 optionally creates reproduced features or embellishments 71 in the printed substrate 47, for example substantially similar to or identical to the features or artistic embellishments 28 provided on the mold 26. First features 28a and second features 28b on mold surface 27 can optionally serve to form reproduced first features 71a and reproduced second features 71b in the printed substrate 47. The reproduced features or embellishments 71 are optionally provided on modified image 36 of the printed substrate 47. For example, reproduced first features 71a can optionally be formed in first areas 22a of the modified image 36 and reproduced second features 71b can optionally be formed in second areas 22b of the modified image 36. Attributes of the features 28 in the original image 21 that have been added in the modified image 36, for example the additional color, can optionally be aligned or registered with the respective reproduced feature or embellishment 71 formed in the printed substrate 47. For example, first color 37 added to the modified image 36 can optionally register with the respective reproduced first features 71a and second color 38 added to the modified image 36 can optionally register with the respective reproduced second features 71b. The reproduced features or embellishments 71 can optionally be referred to as three-dimensional reproduced features or embellishments. The reproduced features or embellishments 71 can optionally serve to form an embellished reproduction 76 on the printed substrate 47 of the original image 21 in which attributes of the reproduced features or embellishments 71 are highlighted, emphasized or enhanced by the modifications made to the digital original image 21 and contained in the modified image 36. Relatively small height differentials between peaks and troughs of the artistic features or embellishments 28 on the mold 26 can facilitate relatively small draws of the printed substrate 47 during the vacuum forming process and thus the creation of relatively fine reproduced embellishments 71.

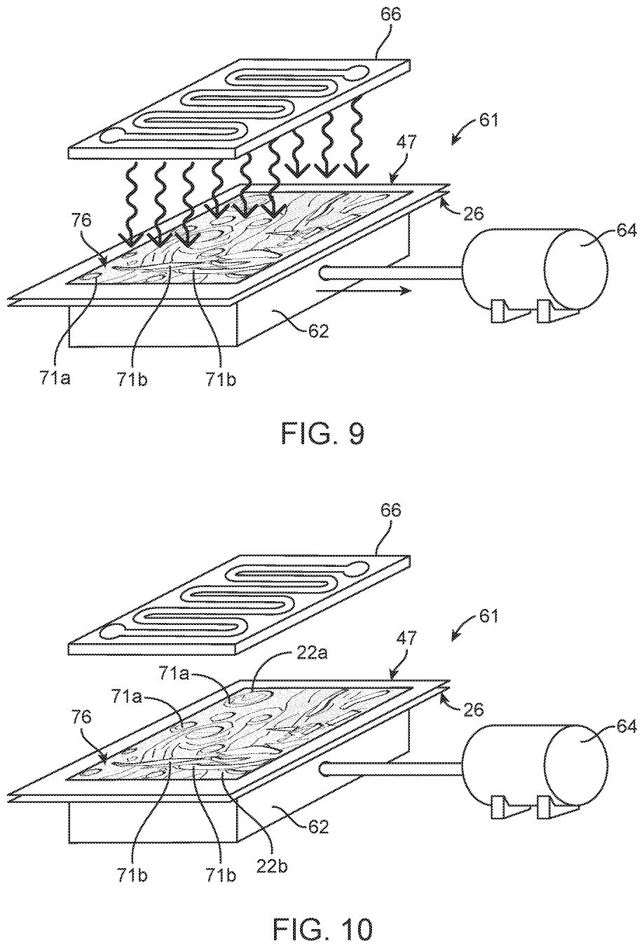

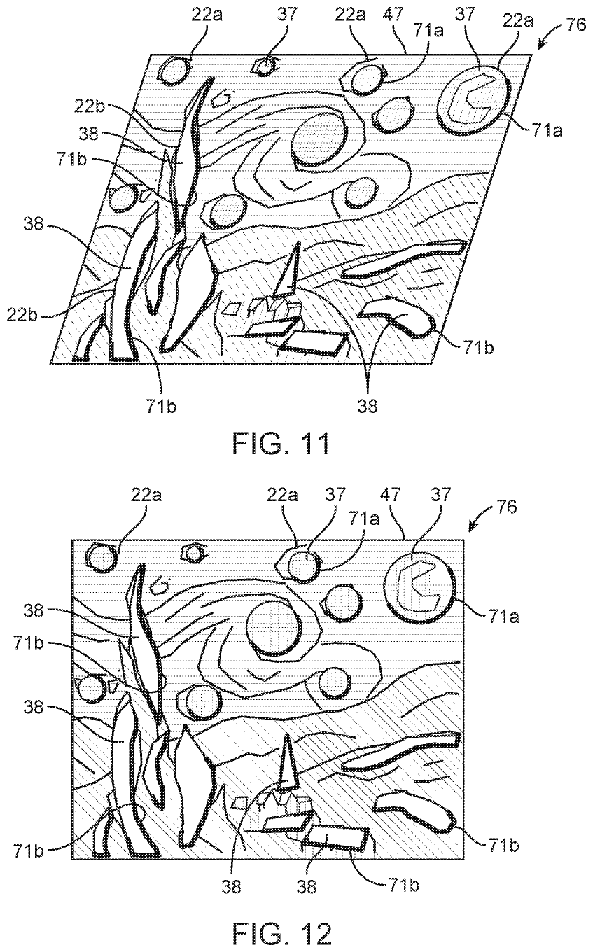

In an optional step, upon completion of the vacuum forming steps the embellished production 76 (see FIG. 10) is optionally removed from the mold 26 and the vacuum table 62 (see FIGS. 11-12).

Embellished reproduction 76 can be mounted on any suitable support structure of an image display. The image display can optionally have the appearance of an image substrate mounted on a wooden stretcher bar frame. The support structure can optionally have a size and shape resembling a wooden stretcher bar frame. The support structure can optionally be a wooden stretcher bar frame or any conventional support structure. The support structure can be formed from any suitable material, including paper, cardboard, paperboard, corrugated board, fiberboard, wood, metal, plastic, foam or any combination of the foregoing. The support structure can be a unitary structure, for example made from a single piece or block of material, or formed from a plurality of parts. The support structure can optionally be any of the types disclosed in U.S. Pat. No. 8,959,812, the entire content of which is incorporated herein by this reference. The support structure can optionally be any of the types disclosed in International Application No. PCT/US21/43803, the entire content of which is incorporated herein by this reference.

The embellished reproductions described herein, which can optionally be referred to as enhanced images, are inexpensive alternatives to currently-available methods of enhancing prints or images, for example mounted prints or images, by manually adding artistic embellishments to the print or image. Use of a mold and vacuum forming technology permits multiple reproductions of a an image with three-dimensional artistic features or embellishments to be easily and inexpensively made. Modifying a digital copy of the image in areas or vicinities in which three-dimensional features or embellishments will be created in the printed image can serve to highlight, enhance or emphasize attributes of such features or embellishments.

As used herein, the terms “front,” “back,” and/or other terms indicative of direction are used herein for convenience and to depict relational positions and/or directions between the parts of the embodiments. It will be appreciated that certain embodiments, or portions thereof, can also be oriented in other positions.

In addition, the term “about” should generally be understood to refer to both the corresponding number and a range of numbers. In addition, all numerical ranges herein should be understood to include each whole integer or fraction thereof within the range. While an illustrative embodiment of the invention has been disclosed herein, it will be appreciated that numerous modifications and other embodiments can be devised by those skilled in the art. Therefore, it will be understood that the appended claims are intended to cover all such modifications and embodiments that come within the spirit and scope of the present invention.

We claim:

1. A method for enhancing an image, comprising providing a sheet having an image formed thereon, providing a digital file of the image, applying three-dimensional artistic embellishments having attributes to an area of the image on the sheet and modifying the image in the digital file in the area to resemble at least some of the attributes of the artistic embellishments applied to the image on the sheet.

2. The method of claim 1, wherein the image is selected from the group consisting of a photograph, a painting, an artistic creation and any combination of the foregoing.

3. The method of claim 1, where in the three-dimensional artistic embellishments are created by an art tool selected from the group consisting of a brush, a pallet knife, a squeeze bottle, a painting tool, any tool that can apply paint, any tool that can apply a chemical and any combination of the foregoing.

4. The method of claim 1, wherein the three-dimensional artistic embellishments resemble artistic embellishments created by an art tool selected from the group consisting of a brush, a pallet knife, a squeeze bottle, a painting tool, any tool that can apply paint, any tool that can apply a chemical and any combination of the foregoing.

5. The method of claim 1, wherein attributes are selected from the group consisting of physical attributes, topographic attributes, elevational attributes, lines, three-dimensional lines, shapes, three-dimensional shapes, surfaces, three-dimensional surfaces, color and any combination of the foregoing.

6. The method of claim 1, wherein the applying step includes applying the three-dimensional artistic embellishments to the image in a color and the modifying step includes adding the color to the area of the image in the digital file.

7. The method of claim 1, wherein the modifying step creates a modified image in the digital file, further comprising printing the modified image on to a thermoformable substrate and forming the three-dimensional artistic embellishments in the thermoformable sheet.

8. A vacuuming forming method for creating an embellished reproduction of an image, comprising providing a mold with a plurality of three-dimensional features on a surface of the mold, modifying a digital file of the image in a computer to create a modified image with a plurality of areas of additional color, printing the modified image on to a thermoformable substrate to create a printed substrate, positioning the mold on a vacuum table, positioning the printed substrate over the mold, registering the plurality of areas of additional color in the modified image on the printed substrate with the plurality of three-dimensional features on the surface of the mold, heating the printed substrate and providing sufficient vacuum to the vacuum table to press the printed substrate on to the mold to form an embellished reproduction of the modified image from the printed substrate and removing the embellished reproduction from the mold.

9. The method of claim 8, further comprising creating the three-dimensional features on a print of the image to create a printed image with three-dimensional features and forming the mold from the printed image with three-dimensional features.

10. The method of claim 8, wherein the plurality of three-dimensional features resemble three-dimensional embellishments created by an art tool selected from the group consisting of a brush, a pallet knife, a squeeze bottle, a painting tool, any tool that can apply paint, any tool that can apply a chemical and any combination of the foregoing.

11. The method of claim 8, wherein the plurality of three-dimensional features on the surface of the mold are arranged in a pattern and the plurality of areas of additional color in the modified image are arranged in the pattern.

12. The method of claim 8, wherein the plurality of three-dimensional features on the surface of the mold include a first plurality of features arranged in a first pattern and a second plurality of features arranged in a second pattern and the plurality of areas of additional color in the modified image include a plurality of areas of a first additional color arranged in the first pattern and a plurality of areas of a second additional color arranged in the second pattern.

13. The method of claim 8, wherein the plurality of three-dimensional features on the surface of the mold have respective two-dimensional shapes and the plurality of areas of additional color in the modified image have the same respective two-dimensional shapes.

14. A method for creating an embellished reproduction of an image, comprising modifying a digital file of the image in a computer to create a modified image with a plurality of areas of additional color, printing the modified image on a substrate to create a printed substrate and forming three-dimensional features in the printed substrate in each of the plurality of areas of additional color.

15. The method of claim 14, wherein the substrate is a thermoformable substrate and the forming step includes vacuum forming the three-dimensional features into the surface of the thermoformable substrate.

16. The method of claim 14, wherein the three-dimensional features resemble three-dimensional embellishments created by an art tool selected from the group consisting of a brush, a pallet knife, a squeeze bottle, a painting tool, any tool that can apply paint, any tool that can apply a chemical and any combination of the foregoing.

17. The method of claim 14, wherein the image is a photograph of a painting and the three-dimensional features resemble brushstrokes on the painting.

18. The method of claim 14, further comprising projecting the modified image on to a surface to indicate where the three-dimensional features should be formed in a mold for use in forming the three-dimensional features in the printed substrate.

19. A modified print of an original image, comprising a print of the original image on a substrate sheet, three-dimensional features formed in the substrate sheet in a plurality of areas of the image and additional color added to the print of the original image in at least some of the plurality of areas of the image.

20. The print of claim 19, wherein the substrate sheet is a thermoformable substrate sheet.

21. The print of claim 20, wherein the three-dimensional features are vacuum formed in the thermoformable substrate sheet.

22. The print of claim 19, wherein the image is of a painting and the three-dimensional features resemble brushstrokes of the painting.

23. The print of claim 19, wherein the three-dimensional features resemble three-dimensional embellishments created by an art tool selected from the group consisting of a brush, a pallet knife, a squeeze bottle, a painting tool, any tool that can apply paint, any tool that can apply a chemical and any combination of the foregoing.

24. The print of claim 19, wherein the print of the original image is a digital print of the original image and wherein the additional color was added to a digital copy of the original image before digitally printing the original image on the substrate sheet.
